(19) United States
(12) Patent Application Publication
(10) Pub. No.: US 2004/0132428 A1
(43) Pub. Date: Jul. 8, 2004

(54) Method and system for privacy preferences management using a synchronisation protocol

(76) Inventor: Michael Mulligan, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/474,847

(22) PCT Filed: Apr. 19, 2001
(86) PCT No.: PCT/EP01/04474

(51) Int. Cl. H04M 1/68

(52) U.S. Cl. 455/411

(57) ABSTRACT

The invention provides a method and/or system for managing privacy preferences in a communication network which comprises a client entity and a network element. The privacy preferences are included in a data object stored in, or accessible to, the client entity. The data object is sent to the network element using a synchronisation protocol, for managing the privacy preferences in accordance with the data object. The synchronisation protocol preferably is the SyncML protocol. Additionally, a proxy element may be provided which communicates with both the client entity and the network element. The client entity preferably may be a user equipment, preferably a computer or mobile station.

### FIELD AND BACKGROUND OF THE INVENTION

This invention generally relates to the management of user privacy preferences in a network.

More specifically, the invention relates to Privacy Preferences Management using a synchronisation protocol such as SyncML.

Generally, the interaction model of the World Wide Web (www) is based on a simple client/server interaction.

FIG. 1 shows the basic structure of such an interaction model. According to this interaction, a client 1 requests a resource from a server (origin server) 2 based on a uniform resource identifier (URI). In response to this request the server 2 is able to provide some service to the client 1. The communication between client 1 and server 2 is indicated by the double-headed arrow 3. In this interaction process, the server 2 will often require data from the client 1. Such data may include the client's PKI Digital Certificate (PKI, Public Key Infrastructure), or some details about the user on whose behalf the client 1 makes the requests (e.g. username/password, users address).

In such an environment, the client 1 can readily determine a user's privacy preferences (due to direct interaction with the user) and act accordingly when personal user data is required.

User privacy preferences can be very complex data objects. They can also tend to be very personalised and unique to individuals. They represent preferences with regards to what data is given out to whom and on what circumstances and situations that data may be used, stored and forwarded. The building up of such a data object represents a substantial investment on behalf of the user.

Due to various constraints in the wireless communication the actual implementation of the interaction model may be different than in the www model. In a wireless connection, additional network elements are preferably introduced to distribute the load across the network.

Such an interaction model for wireless communication is shown in FIG. 2. The constraints which may favour the use of these additional network elements 5, 9 include the following situations: The bandwidth of the network link between a client 4 and an origin server 7 may be very low, or the latency of the link may be poor.

In such cases a Performance Enhancing Proxy (PEP) 5 may be provided which acts as an impedance matching element, matching the characteristics of the wireless network to that of the fixed line network. The functions of PEPs include caching, data encoding and compression, etc.

In other cases the client 4 may be able to indicate that data required by the origin server 7 may be retrieved from a Supporting Server (SS) 9. A Supporting Server is a network element having a higher bandwidth connection to the origin server 7.

The client/origin server interaction requires processing power on the client side which the client normally does not have. In this case the additional network element(s) 5, 9 supplies the required processing power. The communication between client 4, PEP 5, origin server 7, and Supporting Server 9 is indicated by arrows 6, 8, and 10, respectively.

In the environment described above there are many cases when it is desirable (or even necessary) for the network elements 5, 9 performing on behalf of the client to have some knowledge of the users privacy preferences.

For various reasons (including legislative) the distribution of personal data should normally be restricted and governed by strict guidelines. These guidelines have been outlined by authorities such as Federal Trade Commission (FTC) in the USA (or, by authorities e.g. in EU [EU], OECD [OECD] etc.). As an example, the FTC Fair Information Practices are:

Notice—A user should be notified what personal data is used, who is using it, and how it is used;

Choice—A user should be able to choose as to whether or not to allow that use;

Access—A User should have access to such data whereever it is used;

Security—User data should be protected at all times using reasonable security precautions.

When, due to bandwidth and other constraints in a wireless network, use is made of additional network elements such as Supporting Servers (SS) 9 and/or Performance Enhancing Proxies (PEP) 5 to distribute load in the network and to perform many tasks on behalf of clients 4, the additional network elements may need to know the users' privacy preferences in order to perform these tasks and to allow the network elements to conform to the privacy guidelines mentioned.

Current network elements with the ability to support users privacy preferences usually have some graphical user interface (GUI) allowing the user to set preferences directly on the network element. These preferences are unique to that particular network element. This means that if one or more users wish to express their preferences to various network elements they have to set them separately each time for each server.

As an example, consider a case of changing Service Provider where a user wishes to obtain this privacy protection service from a different provider. Currently in proxied privacy solutions those user privacy preferences are entered directly at the network element using a proprietary user interface. The user would have to once again develop his/her privacy preferences and input them in the appropriate network element of the new service provider.

There is a problem that although it would be advantageous for network elements to be aware of a user's personal privacy preferences there is currently no standardized way of updating and managing those privacy preferences.

### SUMMARY OF THE INVENTION

The present invention provides a method and/or system for managing users' privacy preferences in a networked environment such as described above.

In accordance with a preferred aspect of the invention, there is provided a method and/or system for managing privacy preferences in a communication network comprising a client entity and a network element, e.g. a server, wherein the privacy preferences are included in a data object stored in, or accessible to, the client entity, and the data object is sent to the network element using a synchronisation protocol, for managing the privacy preferences in accordance with the data object. The synchronisation protocol preferably is the SyncML protocol.

Additionally, a proxy element may be provided which communicates with both the client entity and the network element. The client entity preferably may be a user equipment, preferably a computer or mobile station.

The client entity or an intermediate proxy element may be adapted to request a policy reference file and/or policy/policies from the server and to determine available privacy preferences based on the received policy/policies and the privacy preferences contained in the data object. In the case of providing an intermediate proxy element, the client entity preferably sends the data object containing the privacy preferences to the intermediate proxy element using the synchronisation protocol.

According to one of the preferred implementations of the invention, the architecture comprises a data object containing the users privacy preferences on the client entity. Use is made of a synchronisation protocol such as the SyncML protocol [SyncML] to synchronise those preferences with versions of the users privacy preferences on network elements. The use of the synchronisation protocol allows preferences to be added, modified, deleted on the client entity and those changes to be propagated to the network element.

Using a synchronisation protocol such as SyncML in this manner provides many advantages for managing user privacy preferences between client entities and network servers. These advantages include:

It allows for a standard method of synchronising privacy preferences between a client entity and network element. Due to the fact that a local copy of the privacy preferences is retained in the client entity, there is no need to enter the privacy preferences separately for each network element. By using this technique, the client entity User Interface (UI) can be used to modify privacy preferences on the client entity. This is very advantageous because it allows the user to modify privacy preferences using a UI she/he is already familiar with. The user only has to learn the operation of only a single UI for modifying privacy preferences. This allows the terminal manufacturer to tailor the UI to best suit the form factor of the client entity.

By having a local copy of their preferences the users have greater control over their privacy preferences.

In situations where the client entity has direct access to origin servers (i.e. unproxied, with no additional network elements) the local privacy preferences can be used for privacy negotiation.

The invention allows to synchronise several remote servers to a single terminal. A user who uses different servers can be provided from all servers with the same user preferences on her/his terminal.

The use of the synchronisation protocol affords the network element a simple mechanism to inform the user that their privacy preferences may need to be updated.

The invention basically provides the ability to synchronize privacy preferences with a server via a synchronisation protocol e.g. via SyncML. The server has the ability to store privacy preferences and synchronize them with a terminal e.g. via SyncML. The terminal such as a Mobile terminal is preferably able to edit and store privacy preferences. The invention does not need to modify any standard. The invention may be used in an end-to-end system for wireless applications.

The mapping of synchronization entities in SyncML, and their possible encoding (if encoded to WBXML) may be standardised.

According to one of the embodiments of the invention, servers in a wireless application environment store privacy preferences and validate services against them on behalf of mobile end-users. When an end-user edits or modifies preferences on a mobile device, these are synchronized via a synchronisation protocol such as SyncML with the information stored on the servers.

This invention thus provides an easy method of managing privacy preferences between a client entity and a network element that requires knowledge of those preferences. The invention proposes the use of a synchronisation protocol, preferably SyncML, as a method of managing user privacy preferences between a client entity and a network element which requires knowledge of those preferences. This network element may be a network server such as a Supporting Server (SS) or it may be a Performance Enhancing Proxy (PEP).

### BRIEF DESCRIPTION OF THE DRAWINGS

FIG. 1 shows a simplified view of the web architecture illustrating the communication between a web client entity and an origin server;

FIG. 2 is a simplified view of the wireless internet showing a client entity and origin server as well as Performance Enhancing Proxies (PEP's) and Supporting Servers (SS's) used to distribute load;

FIG. 3 illustrates an embodiment of the invention architecture showing the use of SyncML with a client entity acting as a SyncML client entity and a network element acting as a SyncML server;

FIG. 4 shows an embodiment of the invention using the P3P protocol; and

FIG. 5 illustrates a further embodiment in accordance with the present invention which uses the P3P protocol and a P3P proxy.

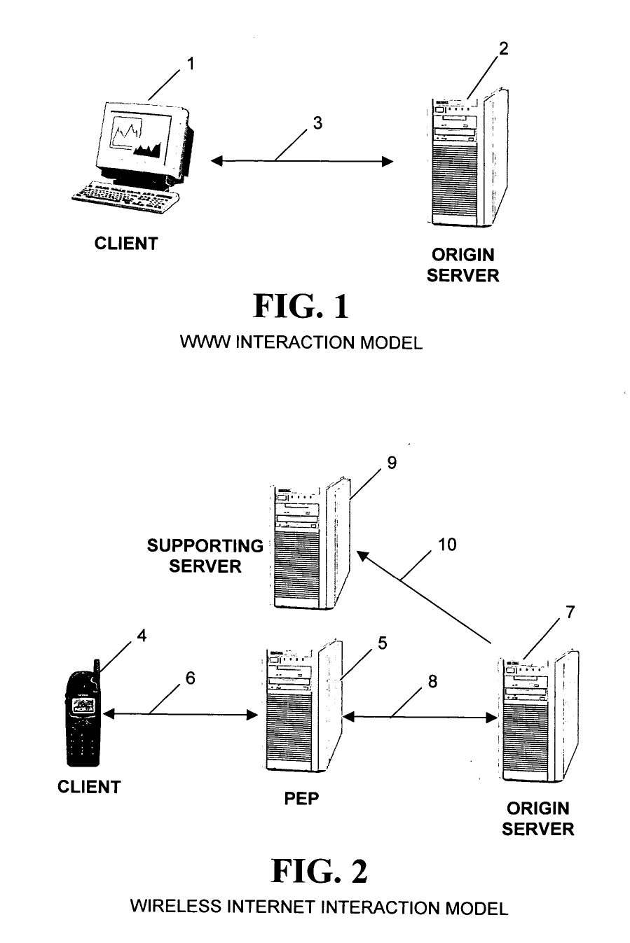

### DESCRIPTION OF PREFERRED EMBODIMENTS OF THE INVENTION

According to preferred embodiments of the invention, both the client and the network element support the use of a synchronisation protocol such as the SyncML protocol. Further, the client entity and the network element have and use an agreed data format for the expression of user privacy preferences. One such well known format is APPEL [APPEL, A P3P Preference Exchange Language].

In addition there is preferably provided a suitable arrangement for the user(s) to modify their privacy preferences. A suitable method is to provide a user interface (UI) in the terminal allowing the user(s) to modify their preferences on the client entity. A synchronisation protocol such as SyncML protocol is used to synchronise those preferences with the users preferences on the network element.

Additionally or alternatively there can be provided a user interface on the network element. The synchronisation protocol, e.g. SyncML protocol synchronises the preferences with the client entity set of preferences. Once synchronised, the client entity set can be used to synchronise with other network elements.

The terminal(s) preferably include an interface to modify user privacy preferences. Further, the terminals are able to connect to a SyncML server in order to transmit those preferences.

Similar features are preferably present in network elements supporting this feature. There is synchronisation protocol (preferably SyncML) support in the network element.

Devices and systems such as networks and/or terminals are preferably implemented such that they support the synchronisation protocol, e.g. SyncML protocol, and provide support for user privacy. The invention can also be related to the WAP standards for providing Privacy in this area. This invention offers a solution to the management of user privacy preferences in an environment which uses proxies containing user privacy preferences.

The invention provides a standard and easy way to synchronize preferences between a wireless terminal and several other servers, as well as for servers to notify the client entity of the necessity of profile updates.

Preferences can be updated on the terminal (off-line), and synchronized only when needed or possible (radio coverage).

The reliance upon synchronization protocols such as SyncML allows a user to synchronize preferences with other users, or with the preferences defined for groups (e.g. clubs, subscriber categories, etc). This is a useful feature, since the exchange of privacy preferences in the P3P framework may be complicated.

In general, the synchronisation protocol such as SyncML can be used for a variety of synchronization and update purposes.

According to a preferred implementation of the invention, there is provided the ability to mapping of the preference synchronization to SyncML commands and constructs. The synchronisation protocol can be extended with code pages specifically meant for privacy preferences, e.g. if WBXML [Wireless (or WAP) Binary XML, XML Extensible Markup Language] encoding is considered.

The exchange of privacy preferences among entities in the network may use the security features of SyncML.

Considering e.g. the above discussed case of changing Service Provider where a user wishes to obtain the privacy protection service from a different provider, the user does no longer have to once again develop his/her privacy preferences and input them in the appropriate network element of the new service provider. Using the present invention the privacy preferences are stored locally and can be sent to the new network element, requiring only a synchronising with the new network element.

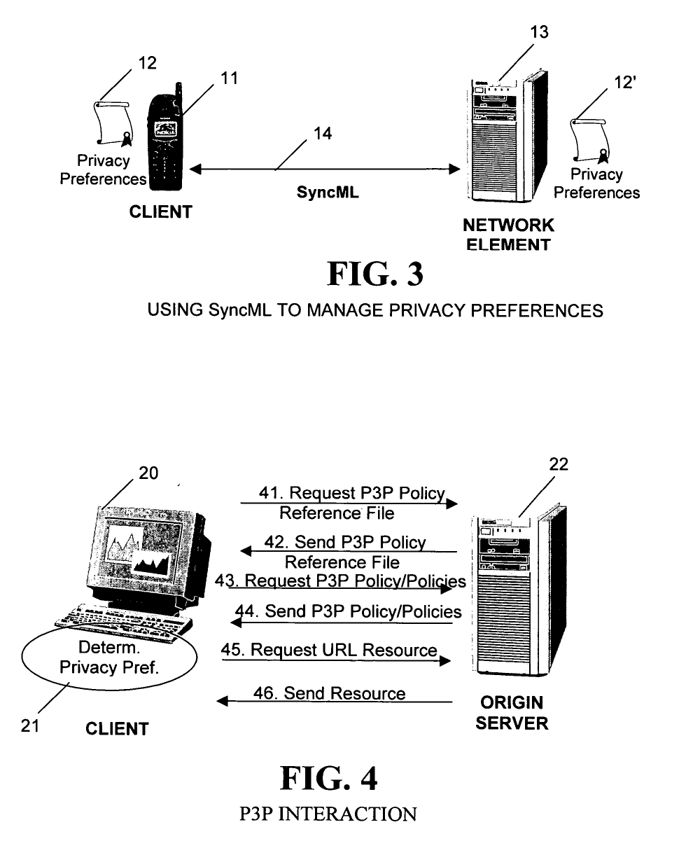

The architecture of an embodiment of the invention is shown in FIG. 3. It comprises a data object (data file) 12 containing the users privacy preferences on a client entity 11 and also the use of a synchronisation protocol 14, preferably SyncML protocol [SyncML], to synchronise those preferences with versions (data object 12′) of the users privacy preferences on network elements such as network element 13. The client entity 11 is in this case a mobile terminal such as a mobile phone. The use of the synchronisation protocol allows preferences to be added, modified, deleted on the client entity and those changes to be propagated to the network element.

In the embodiment shown in FIG. 3, the client entity 11 acts as a SyncML client entity and the network element 13 acts as a SyncML server. The data which is being synchronised between them are in a format that is agreed by both parties. One possibility is to use the APPEL [APPEL] privacy preferences language as specified by W3C, however other data representations may also be used.

The following uses cases and embodiments show and describe use possibilities and advantages of the invention.

A first use case implemented in the embodiment shown in FIG. 4 is the use of P3P (P3P—Platform for Privacy Preferences). The W3C (W3C—World Wide Web Consortium) has defined an XML standard for the exchange of privacy information. Basically, P3P is an XML document and handshake which allows a web site to express the data collected by the website and the intended use of that data. A client entity on receipt of an P3P document can then compare the document with privacy preferences of the user. In addition, the P3P project contains a standard user privacy preferences language APPEL.

The flow of P3P is described in FIG. 4. When a client entity 20 is instructed, e.g. by a user, to retrieve a resource from a network element such as an origin server 22 (using e.g. a URL) it first retrieves (steps 41, 42) a P3P policy reference file from the origin server 22. This file determines the location of P3P policies which reflect the privacy policy of different parts of the web site. The client entity 20 then retrieves (steps 43, 44) the appropriate policies from the origin server 22. Once the policies are retrieved the client entity 20 compares the policies to the users privacy preferences as indicated by field 21 “Determine Privacy Preferences”. If the comparison is favourable the user's original request is executed, i.e. the URL resource indicated by the user is requested (step 45) from the origin server 22 which returns the requested resource (step 46).

In some cases, use of P3P may not be favourable in a constrained environment such as wireless, due to the number of additional protocol exchanges required to access a website when using P3P. As a result thereof there have been proposals to introduce a P3P performance enhancing proxy (P3P PEP) for performing the protocol exchanges on behalf of the client entity.

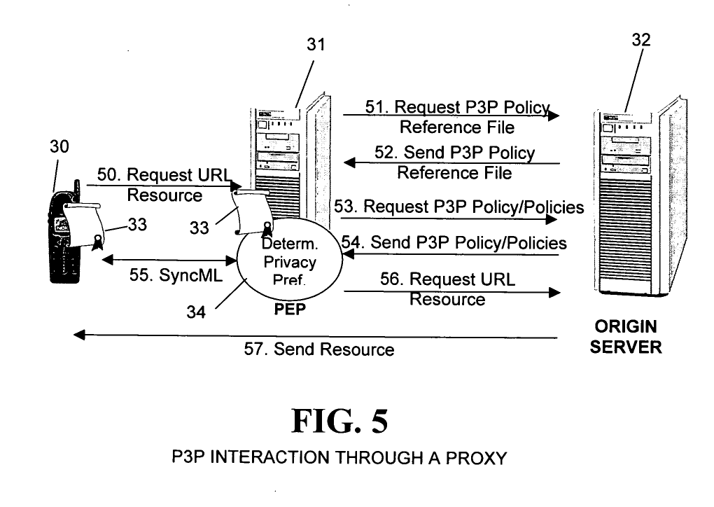

FIG. 5 shows an embodiment employing such a PEP 31. One of the problems associated with a P3P proxy solution is the need to provide a mechanism for the client entity to communicate it's privacy preferences to the P3P proxy. This problem can easily be solved with the present invention. The SyncML protocol allows for the synchronisation of privacy preferences between the client entity and the P3P proxy.

FIG. 5 illustrates a P3P interaction through a proxy 31. A client entity 30, e.g. a mobile phone, includes and stores a data object 33 which contains the privacy preferences of the client entity 30 which have e.g. been input by the user of client entity 30, or are prescribed by another source.

In a step 50, the client entity sends a request to the PEP 31 requesting a resource which is e.g. indicated by the URL (Universal Resource Locator) of the resource. In a step 51, the PEP 31 requests the P3P Policy Reference File from a network element (e.g. origin server) 32 which is sent to PEP 31 in step 52. This file determines the location of P3P policies which reflect the privacy policy of different parts of the web site. The PEP 30 then requests (step 53) the appropriate policies from the origin server 32 which returns these policies in step 54.

Once the policies are retrieved the PEP 31 compares the policies to the users privacy preferences as indicated by field 34 “Determine Privacy References”. If the comparison is favourable the user's original request is executed, i.e. the URL resource indicated by the user is requested (step 56) from the origin server 32 which returns the requested resource directly to the client entity (step 57).

In the embodiment shown in FIG. 5, the stored data object 33 containing the privacy preferences of the client entity 30 is copied to the PEP 31 using the synchronisation protocol, preferably SyncML, in a step 55 so as to provide the PEP 31 with the user's privacy preferences.

Step 55 may be carried out immediately following step 50 or at any time before implementing step 34.

Although preferred embodiments have been described above, the invention can also be carried out in different manner and intends to cover any such modification, addition, or omission of the described features.

1. Method for managing privacy preferences in a communication network comprising a client entity and a network element, wherein the privacy preferences are included in a data object stored in, or accessible to, the client entity, and the data object is sent to the network element using a synchronisation protocol, for managing the privacy preferences in accordance with the data object.

2. Method according to claim 1, wherein the synchronisation protocol is SyncML.

3. Method according to any one of the preceding claims, wherein a proxy element is provided which communicates with both the client entity and the network element.

4. Method according to any one of the preceding claims, wherein the client entity is a user equipment, preferably a computer or mobile station.

5. Method according to any one of the preceding claims, wherein the client entity requests a policy reference file and/or policy/policies from the network element and determines available privacy preferences based on the received policy/policies and the privacy preferences contained in the data object.

6. Method according to any one of the preceding claims, wherein an intermediate proxy element requests a policy reference file and/or policy/policies from the network element and determines privacy preferences based on the received policy/policies and the privacy preferences contained in the data object.

7. Method according to claim 6, wherein the client entity sends the data object containing the privacy preferences to the intermediate proxy element using the synchronisation protocol.

8. Method according to any one of the preceding claims, wherein the client entity and the network element use an agreed data format for the expression of user privacy preferences, preferably the format APPEL [APPEL, A P3P Preference Exchange Language].

9. Method according to any one of the preceding claims, wherein the network element is a server.

10. System for managing privacy preferences in a communication network comprising a client entity and a network element, wherein the privacy preferences are included in a data object stored in, or accessible to, the client entity, and the client entity is adapted to send the data object to the network element using a synchronisation protocol, for managing the privacy preferences in accordance with the data object.

11. System according to claim 10, wherein the synchronisation protocol is SyncML.

12. System according to any one of the preceding system claims, wherein a proxy element is provided which is adapted to communicate with both the client entity and the network element.

13. System according to any one of the preceding system claims, wherein the client entity is a user equipment, preferably a computer or mobile station.

14. System according to any one of the preceding system claims, wherein the client entity is adapted to request a policy reference file and/or policy/policies from the network element and to determine available privacy preferences based on the received policy/policies and the privacy preferences contained in the data object.

15. System according to any one of the preceding system claims, wherein an intermediate proxy element is provided which is adapted to request a policy reference file and/or policy/policies from the network element and to determine privacy preferences based on the received policy/policies and the privacy preferences contained in the data object.

16. System according to claim 15, wherein the client entity is adapted to send the data object containing the privacy preferences to the intermediate proxy element using the synchronisation protocol.

17. System according to any one of the preceding system claims, wherein the client entity and the network element use an agreed data format for the expression of user privacy preferences, preferably the format APPEL [APPEL, A P3P Preference Exchange Language].

18. System according to any one of the preceding system claims, wherein the network element is a server.
